(19) United States
(12) Patent Application Publication
(10) Pub. No.: US 2009/0322099 A1
(43) Pub. Date: Dec. 31, 2009

(54) Rotational generator method and rotational generator

(76) Inventor: Fred George Labankoff, Santa Rosa, CA (US)

Correspondence Address: Fred George Labankoff, 3828 Skyfarm Drive, Santa Rosa, CA, 95403, US

(21) Appl. No.: 12/217,085

(22) Filed: Jun. 30, 2008

(51) Int. Cl. F03G 7/08; H02K 53/00

(52) U.S. Cl. 290/1 R; 415/916

(57) ABSTRACT

A parasitic electric generator which captures and converts rotation mechanical energy of rotating wheels of a source of rotation (rotating wheeled aircraft, ships or machines and vehicles such as but not limited to autos, trucks, buses, tractors, rail trains) into electricity. This electricity is generated by magnets attached/embedded in/on the rotating wheels. Such wheels with attached/embedded magnets rotating perpendicularly and within a series of wire coils creates a magnetic flux in such coils of wire causing an electric current. The purpose of such electric current is to 1) power the source of rotation, and/or, 2) recharge/supplement the source of rotation's battery or batteries, and/or 3) perform electrolysis of water into hydrogen gas and oxygen gas common called Brown's gas for further accumulation as a fuel. (122 words)

This invention is of both a method as well as device which captures and converts coincident lost or ignored rotational mechanical energy of existing wheels on common moving objects such as cars, trucks, trains, as well as others, into electricity to further power such machines, refrigerate, and generate cheap electricity to generate hydrogen and oxygen gas by electrolysis.

Basically the invention is parasitic in nature as it uses the existing rotation of wheels of automobiles, trucks, trains in motion or anything that are powered by rotational mechanical power source to rotate a magnet attached to the rotating wheel which is surrounded by a coil or wire so as to generate electricity.

This is not a perpetual motion machine nor infinite energy machine. The additional weight the magnets and coil have minimal effect on the car, truck or train. The invention is an excellent auxiliary battery generator for hybrid vehicles with an eye for extending the range of the vehicle especially during this petroleum crises or powering trucks with refrigeration or supplementing power to a electro-diesel train as it rolls down the line. The invention could work also on specific jets and aircraft as well as sea ships. Most importantly the train version with multiple rotational generators can easily be modified to act as a cheap hydrogen generator by using such electricity to perform electrolysis of water to generate both oxygen gas and hydrogen gas both cheaply.

### FIELD OF INVENTION

This invention relates to electric generators powered by utilizing part of the mechanical energy of a rotating wheel here to fore wasted.

### DESCRIPTION OF PRIOR ART

Relevant Prior Art includes

U.S. Pat. No. 3,699,367

U.S. Pat. No. 3,760,351

U.S. Pat. No. 6,291,901

U.S. Pat. No. 4,298,910

U.S. Pat. No. 5,783,600

U.S. Pat. No. 2,256,794

U.S. Pat. No. 4,939,707

It appears that prior art has not addressed the specific question of recapture and regeneration of existing wasted or here to fore ignored mechanical rotational energy such as the rotation of car, truck and train wheels into additional electric energy to power such vehicles further or to refrigerate moving trucks or trains or serve as a cheap source of electricity of water to accomplish hydrogen electrolysis.

Two such prior embodiments refers to generators that fit within the tire of the vehicle whose wheels are rotating but limited to powering sensors, monitors and other devices but not aiding in the powering of such vehicle. U.S. Pat. Nos. 3,699,367 and 3,760,351.

Electrical power generating tire system is addressed in U.S. Pat. No. 6,291,901 creates electricity by the deflection of a rotating tire not the energy of rotation of the tire and wheel

The concept of utilizing existing mechanical rotational energy to produce light was addressed in U.S. Pat. Nos. 4,298,910 and 5,873,600 relating to powering a led by an internal skate wheel generator but not to power the rotation of the roller skate.

Likewise in U.S. Pat. No. 2,256,794 addresses a bicycle wheel generator to generate electricity for light but not to power the bicycle itself.

The idea of an electronic wristwatch having an electric generator also utilizing mechanical motion of the wearers arm was addressed in U.S. Pat. No. 4,939,707. This seems like the closes prior embodiment as to self power but again of a watch not an automobile, truck, train or other moving vehicle or vessel.

Though in these prior embodiments address the rotating wheels of the device to generate electricity they do not address using such wasted mechanical rotational energy of wheels of automobiles, trucks, trains, other vehicles or vessels, to created electricity to power such vehicles nor to provide refrigeration nor to provide cheap electrical energy to separate out hydrogen and oxygen gas from water by electrolysis.

### SUMMARY OF THE INVENTION

Much of the energy used to power automobiles, trucks, trains and other vehicles as well as vessels and even aircraft is not directed at moving the object forwards or reverse, it is lost to the surrounding environment. This patent address that lost energy or here to for not considered waste of rotational mechanical energy, capture it and regenerate it into cheap electricity to further propel the original vehicle, to refrigerate it contents or to serve as a cheap electric energy source to separate out hydrogen and oxygen gas from water by electrolysis.

In our present world with its energy crisis, it is imperative to tap all sources of energy and to look and see those which have not been effective addressed nor tapped such has electrolysis generation of hydrogen and oxygen gases. The cost of electricity historically has been too high. The rotational generator uses energy thought lost and so it is a source is cheap electrical energy.

The electrolysis would be achieved by having a number of rotation generators say on a train generating electricity while moving other goods in there normal box cars from point a to point b. A tanker car would hold the water subject to electrolysis, the water electrified, and the resulting hydrogen and oxygen would be collected in separate tanker cars where it would be compressed. One train could have hundreds of rotational generators all producing electricity from the same locomotives ment to just move goods from point a to point b. This cost locomotion of the train is a sunk cost which it further mitigated by the rotational generator. This is also true for refrigerator cars which use the energy of the rotational generator to power the refrigerator compressors. This coincident mechanical energy is the key which allows automobiles, trucks, trains and other vehicles and vessels to be tapped with very minor friction or additional weight to generate additional energy a unintended consequence over looked since automobiles, trucks and trains were invented.

### BRIEF DESCRIPTION OF THE FIGURES

FIG. 1 Lateral view of the rotational generator mounted on a wheel.

FIG. 2. Cross-sectional view of the rotational generator mounted on a wheel.

### DETAILED DESCRIPTION OF PREFERRED EMBODIMENTS

It is very simple

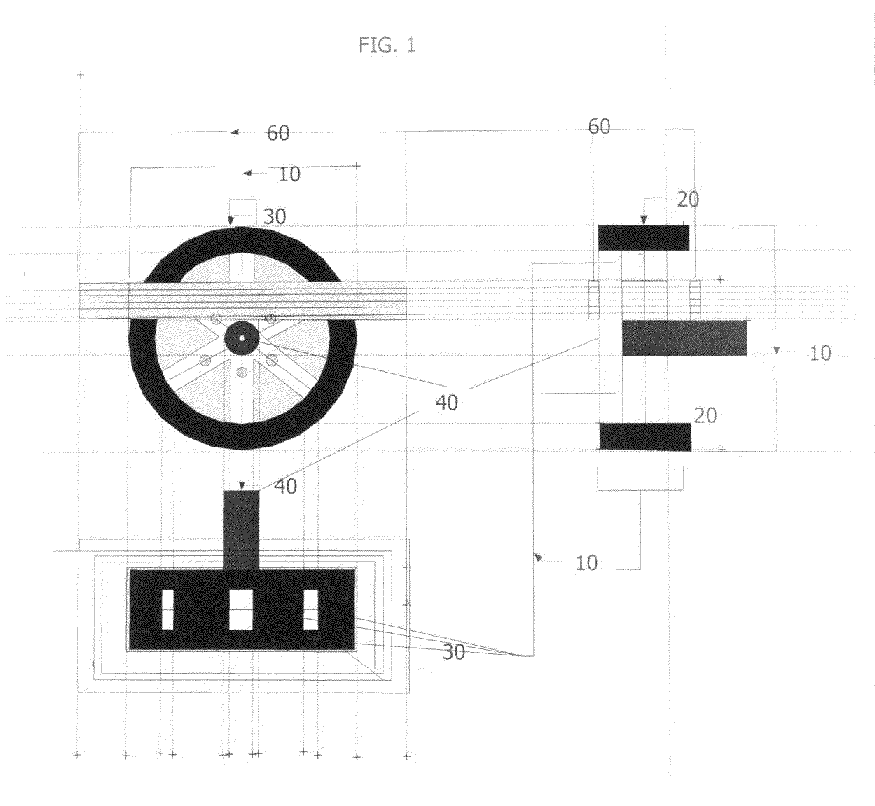

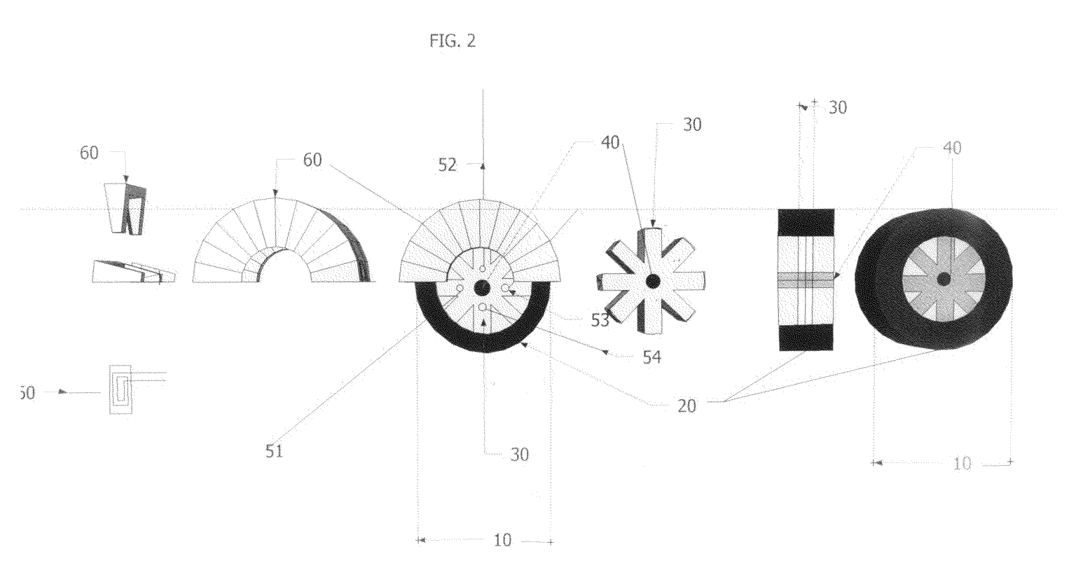

Referring to the drawings, FIG. 1 lateral view and FIG. 2 cross sectional view refer to a wheel as on automobile, truck or train. The wheel is referred to as 10. The magnets are referred to as 30 and are mounted on wheel (10) alternatively wheel (10) may be made of magnetic strips The axle upon which the wheel rotates is 40. The lug nuts which hold the both the magnets (30) as well as wheel (10) to the axle are 51, 52, 53, 54 The wire coil is 60. The axle rotating the wheel (10) is 70. Parts (10), (30), (51, 52, 53, 54) and( 70) must not touch (60) but rotate within (60). An electric current develops from such rotation of(10), (30), (51, 52, 53, 54), (70) inside of (60).

With respect to autos and trucks, tires 20 may be mounted upon wheel (10).

I claim I have invented:

1. An electrical power generating method and device for generating electricity from the coincident rotational mechanical energy of moving wheels of automobiles, trucks or trains or any rotating device to which magnets are attached to such rotating wheels and the rotating such wheel with magnet thereon within a wire coil surrounding such converting rotating the magnetic flux to an electric current to be used to help power the automobile, truck, train or what ever, charge batteries, power electric refrigeration or serve as a cheap source of electricity to generate oxygen and hydrogen by electrolysis of water.
